(19) United States
(12) Patent Application Publication
(10) Pub. No.: US 2016/0177726 A1
(43) Pub. Date: Jun. 23, 2016

(54) EXHAUST-GAS TURBOCHARGER

(71) Applicant: Bosch Mahle Turbo Systems GmbH & Co. KG, Stuttgart (DE)

(72) Inventors: Thomas Striedelmeyer, Stuttgart (DE); Jochen Schray, Oberriexingen (DE)

(21) Appl. No.: 14/973,698

(22) Filed: Dec. 17, 2015

(30) Foreign Application Priority Data
Dec. 18, 2014 (DE) 102014226477.4

(51) Int. Cl. F01D 5/02; F01D 5/12; F04D 29/28

(52) U.S. Cl. CPC F01D 5/027; F04D 29/284; F01D 5/12; F05D 2220/40; F05D 2240/60; F05D 2260/96; F05D 2300/174

(57) ABSTRACT

An exhaust-gas turbocharger may include a compressor wheel and a turbine wheel connected fixedly in terms of rotation to the compressor wheel via a shaft. The turbine wheel may have a hub, a disc-like wheel back, and a plurality of blades extending radially from the hub and axially from the wheel back. The wheel back may include at least one cut-out region of reduced axial thickness.

### CROSS-REFERENCE TO RELATED APPLICATIONS

This application claims priority to German Patent Application No. 10 2014 226 477.4, filed Dec. 18, 2014, the contents of which are hereby incorporated by reference in their entirety.

### TECHNICAL FIELD

The invention relates to an exhaust-gas turbocharger having a turbine wheel, which is connected fixedly in terms of rotation to a compressor wheel via a shaft, the turbine wheel having a hub, a disc-like wheel back and a plurality of blades extending radially from the hub and axially from the wheel back.

### BACKGROUND

In the automotive sector, what is termed downsizing is used for reducing the consumption of internal combustion engines. In this respect, the swept volume of the internal combustion engines is reduced, and use is additionally made of a supercharging device, for example an exhaust-gas turbocharger, in order to achieve the desired power. On account of reduced throttling losses and frictional losses, it is thereby possible to improve the efficiency of the internal combustion engine. However, exhaust-gas turbochargers exhibit a relatively poor response behaviour, in particular in the case of low rotational speeds of the internal combustion engine, this generally being referred to as turbo lag. In the event of low powers, for example in the event of low rotational speeds or during idle running, there is not enough energy in the exhaust-gas stream for bringing the turbocharger to a sufficient rotational speed, and therefore the charge pressure is too low. The time which the exhaust-gas turbocharger requires for arriving at the rotational speed needed for the required power, after an increased power is demanded of the internal combustion engine, defines the turbo lag. Particularly in the downsizing of internal combustion engines in which a relatively large increase in power is achieved by the exhaust-gas turbocharger, the turbo lag is particularly pronounced, since a relatively large turbocharger is required, this in turn requiring more energy in order to achieve the appropriate rotational speed. For this reason, the moment of inertia of the turbocharger has to be reduced, as a result of which the response behaviour of the exhaust-gas turbocharger can be improved.

By way of example, this can be achieved through the use of lightweight, high-strength materials. Since at least the turbine wheel of the exhaust-gas turbocharger is exposed to very high temperatures in the exhaust tract, the selection of possible lightweight materials is limited. One possibility is represented by what are termed titanium aluminide alloys, these being temperature-resistant and having a high specific strength. However, titanium aluminide compounds of this type display irreversible plastic deformation on the turbine wheel through high temperatures, centrifugal forces and creep effects. This can in turn create an imbalance in the turbine wheels and also reduce the service life of the turbine wheel.

Moreover, the moment of inertia of the turbine wheels can be improved by the targeted adaptation of the geometry, for example by scalloping of the turbine wheels. In this case, the wheel back is cut out between the blades, saving weight in regions of the turbine wheel which are remote from the axis, as a result of which the moment of inertia is reduced. However, this has the effect that exhaust gas can flow past behind the turbine blades, and therefore the efficiency of the turbine wheel and thus of the exhaust-gas turbocharger is impaired.

### SUMMARY

The present invention is based on the object of providing an improved or at least further embodiment for an exhaust-gas turbocharger, in particular for a turbine wheel of an exhaust-gas turbocharger, which is distinguished in particular by the fact that the moment of inertia is improved and the service life is extended, without thereby impairing the efficiency.

This object is achieved according to the invention by the independent claims. Advantageous developments are the subject matter of the dependent claims.

The invention is based on the general concept of designing a turbine wheel made of titanium aluminide in such a manner that component stresses in the wheel back of the turbine wheel are reduced, giving rise to reduced plastic deformation and thereby to less imbalance on the turbine wheel during use of the turbine wheel. This is achieved by virtue of the fact that the wheel back of the turbine wheel has at least one cut-out region of reduced axial thickness. This cut-out region is located in particular radially on the outside of the wheel back, such that as a result firstly the moment of inertia is reduced and secondly the material cut out on the wheel back does not generate any centrifugal forces, which would have to be retained by the material of the wheel back and therefore would generate stresses in the material. It is thus possible to thereby reduce both the moment of inertia and also stresses in the wheel back which would lead to imbalance. The response behaviour of the exhaust-gas turbocharger is improved as a result. Moreover, the generation of noise is reduced and the service life of the bearing system for the exhaust-gas turbocharger is extended.

One advantageous possibility provides that the at least one cut-out region is formed by a shoulder on the wheel back, said shoulder separating the at least one cut-out region from the rest of the wheel back. The rest of the wheel back therefore has a greater axial thickness than the cut-out region.

It is preferable that the rest of the wheel back is located radially within the at least one cut-out region. It is thereby possible for the rest of the wheel back to bear the centrifugal forces which arise without thereby generating an excessive moment of inertia, while the outer cut-out regions furthermore prevent an unfavourable exhaust-gas flow, and therefore it is not necessary to accept any losses in efficiency as a result of the cut-out regions.

In the description and in the claims, a shoulder is understood to mean an interruption in a profile of a surface in the manner of a step. In particular, a shoulder has at least one, preferably at least two, turning points. By way of example, a shoulder has two kinks in a surface, which can also be formed in each case by a radius and lead to an offset in the surface.

A further advantageous possibility provides that, in a radially outer region of the at least one cut-out region, the wheel back has an axial thickness which is smaller than one thirtieth, preferably smaller than one fortieth and more preferably smaller than one fiftieth of the diameter of the turbine wheel.

A particularly advantageous possibility provides that the at least one cut-out region is formed on a rear side of the wheel back which is remote from the flow. In this way, the formation of the at least one cut-out region does not influence the flow properties of the turbine wheel, and therefore the efficiency of the exhaust-gas turbocharger is not impaired.

A further particularly advantageous possibility provides that the shoulder runs in a circular manner and coaxially in relation to the axis of rotation on the rear side of the wheel back. The at least one cut-out region can thus be formed in a very simple manner without the generation of an imbalance.

One advantageous solution provides that the at least one cut-out region runs in an annular manner between a first diameter and a second diameter, the first diameter corresponding to a diameter of the wheel back. As a result, the at least one cut-out region is formed on the outside of the wheel back of the turbine wheel. A reduction in weight, which can be saved on the outside, makes a particularly effective contribution to reducing the moment of inertia.

A further advantageous solution provides that the turbine wheel has a balancing region, this having a substantially planar annular surface on the rear side of the turbine wheel, at which material can be removed in order to balance out the turbine wheel. Since the turbine wheel of the exhaust-gas turbocharger reaches an extremely high rotational speed during operation, it is advantageous if the turbine wheel can be balanced out.

A particularly advantageous solution provides that the balancing region is located between the second diameter and a third diameter, the first diameter being greater than the second diameter and the second diameter being greater than the third diameter. The at least one cut-out region is therefore located radially outside the balancing region, and therefore the reduction in thickness within the cut-out region can have a particularly advantageous effect on the moment of inertia of the turbine wheel. In addition, the balancing region is located in a radially adjoining manner within the at least one cut-out region. As a result, the balancing region is located far enough outwards in radial terms that the turbine wheel can be balanced out effectively by removal of material within the balancing region.

An advantageous variant provides that the at least one cut-out region is formed on a flow side of the wheel back. In this way, it is possible for the axial thickness of the wheel back to be adapted even more flexibly.

A further advantageous variant provides that the cut-out region is located between the blades. The cut-out region can be arranged at this location in a particularly advantageous manner without thereby weakening the wheel back in regions in which a high axial thickness is required for the stability of the turbine wheel.

A particularly advantageous variant provides that the shoulder runs in an arc between the cut-out region and the rest of the wheel back, the shoulder being at a smaller distance from the axis of rotation centrally between two blades than in regions closer to the blades. In this way, it is possible for the at least one cut-out region to be arranged in an advantageous manner without having an unfavourable influence on the exhaust-gas flow.

One advantageous possibility provides that the shoulder has a profile in the form of an arc of a circle. Such a profile of the shoulder is easy to produce in geometrical terms.

A particularly advantageous possibility provides that the turbine wheel comprises titanium aluminide, in particular gamma TiAl. Titanium aluminide is a lightweight, heat-resistant material, and is therefore readily suitable for the turbine wheel of the exhaust-gas turbocharger. The stresses within the turbine wheel which are reduced by the design of the wheel back, in particular the reduced stresses within the wheel back, have a particularly advantageous effect in the case of a turbine wheel made of titanium aluminide.

Further important features and advantages of the invention become apparent from the dependent claims, from the drawings and from the associated description of the figures on the basis of the drawings.

It is self-evident that the features mentioned above and the features still to be explained below can be used not only in the combination given in each case but also in other combinations or on their own, without departing from the scope of the present invention.

Preferred exemplary embodiments of the invention are shown in the drawings and will be explained in more detail in the description which follows, identical reference signs relating to identical or similar components or components of identical function.

### BRIEF DESCRIPTION OF THE DRAWINGS

In the drawings, in each case schematically,

FIG. 1 shows a side view of a turbine wheel according to the invention,

FIG. 2 shows a perspective illustration of the turbine wheel shown in FIG. 1 obliquely from above, such that a wheel back of the turbine wheel is visible,

FIG. 3 shows a side view of a turbine wheel according to a second embodiment, and

FIG. 4 shows a front view of the turbine wheel shown in FIG. 3, a flow side of the turbine wheel being visible.

### DETAILED DESCRIPTION

A turbocharger (not shown) comprises a turbine wheel 10, which is connected fixedly in terms of rotation via a shaft 12 to a compressor wheel (not shown), which is mounted rotatably about an axis of rotation 14 and which is driven by an exhaust-gas stream. The turbine wheel 10 has a hub 16, a wheel back 18 and a plurality of blades 20 extending, on a flow side 41, radially outwards from the hub 16 and axially from the wheel back 18. The blades 20 thus extend in a region spanned by the hub 16 and the wheel back 18. The blades 20 in this respect run in an arc, such that flow energy from the exhaust-gas stream can be converted into a rotational movement of the turbine wheel 10 by the blades 20. As a result, the turbine wheel 10 and therefore also the compressor wheel of the exhaust-gas turbocharger can be driven by the exhaust-gas stream. No blades 20 are arranged on a rear side 23 of the wheel back 18 remote from the flow, and therefore the rear side 23 has a low flow resistance.

In order to reduce the moment of inertia of the turbine wheel 10 and stresses within the wheel back 18 of the turbine wheel 10, the wheel back 18 of the turbine wheel 10 has a cut-out region 22, this having an axial thickness 24 which is reduced compared to an axial thickness 26 of the rest of the wheel back. In order to reduce the stresses within the wheel back 18, it is advantageous if the axial thickness 26 of the rest of the wheel back is greater than 2.5 times the axial thickness 24 in the cut-out region 22.

The wheel back 18 is in this case defined as a disc which runs perpendicularly to the shaft 12 and which in turn is formed by two individual discs, a first disc 28 having a first diameter 30 which is greater than a second diameter 32 of the second disc 34. The first diameter 30 in this case corresponds to the diameter of the wheel back 18. The first disc 28 is arranged on the flow side and the second disc 34 is arranged in a manner remote from the flow, and therefore the cut-out region 22 is formed in an annular manner, on the rear side 23 of the wheel back 18 remote from the flow, between the first diameter 30 and the second diameter 32. The axial thickness 24 within the cut-out region 22 is given by the axial thickness of the first disc 28, and the axial thickness 26 of the rest of the wheel back is given by the sum total of the axial thicknesses of the first disc 28 and of the second disc 34.

The cut-out region 22 is separated from the rest of the wheel back 18 by a shoulder 40. The shoulder 40 is formed level with the second diameter 32 by virtue of the second disc 34 of the wheel back 18 extending only as far as the shoulder 40. As a result, the shoulder 40 runs in an annular manner and coaxially in relation to the axis of rotation 14. Furthermore, the shoulder 40 brings about the reduction in the axial thickness 24 in the cut-out region 22.

The shoulder 40 can be formed, for example, by a bevel. As an alternative or in addition thereto, provision can also be made of one or more radii, which bring about an offset in the surface of the wheel back 18 within the second diameter 32 in relation to the surface of the wheel back 18 in the cut-out region 22.

A balancing region 36 having a substantially planar annular surface 37 is arranged on the rear side 23 of the wheel back 18. Material can be removed from the surface 37 in order to balance out the turbine wheel 10. The balancing region 36 extends radially between the second diameter 32 and a third diameter 38. The balancing region 36 is separated from the cut-out region 22 radially to the outside by the shoulder 40. As a result, the balancing region 36 is still located in a region remote from the axis, and therefore an imbalance in the turbine wheel 10 can be compensated for by the removal of material in the balancing region 36.

The third diameter 38 is characterized by a transition on the rear side 23 of the wheel back 18 from the planar surface 37 in the balancing region 36 to a curved surface 39, the latter forming a transition to the hub 16 on the rear side 23 of the wheel back 18 remote from the flow.

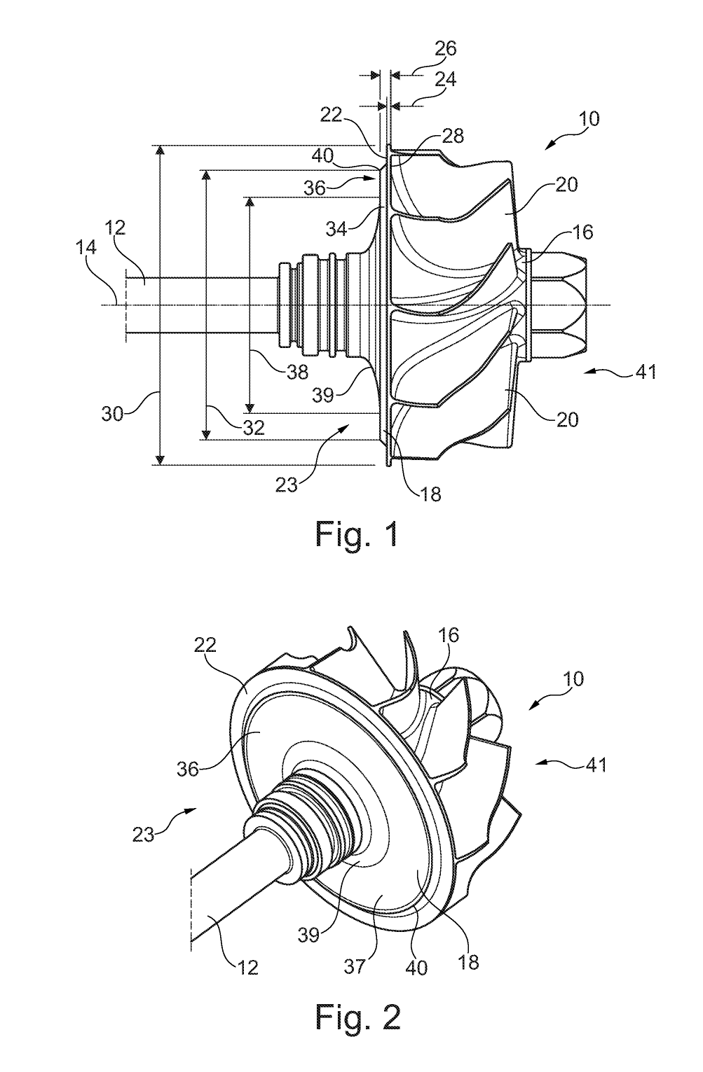

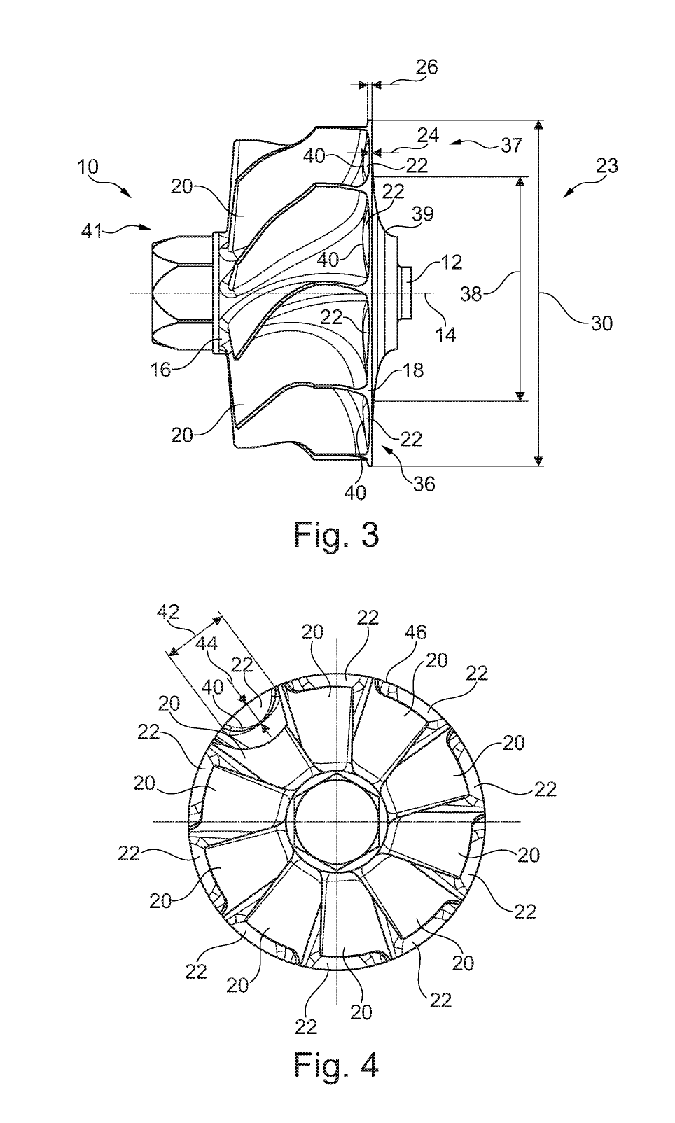

A second embodiment of the exhaust-gas turbocharger, shown in FIGS. 3 and 4, differs from the first embodiment of the exhaust-gas turbocharger shown in FIGS. 1 and 2 in that the at least one cut-out region 22 is arranged on the flow side 41 of the wheel back 18. The reduced axial thickness 24 of the cut-out region 22 is thus reduced by virtue of the fact that a surface of the flow side 41 of the wheel back 18 is offset axially in the direction of the rear side 23.

The cut-out region 22 runs between the blades 20 on the flow side 41. In particular, a cut-out region 22 runs in each intermediate region between two blades 20. The cut-out region 22 preferably extends centrally between two blades 22, and has a width 42 in the circumferential direction which corresponds at most to the distance between the blades 20 level with the first diameter 30. It is also possible, however, for the width 42 of the cut-out region 22 to be smaller than the distance between two blades 20, such that the cut-out region 22 does not extend as far as the blades 20.

The cut-out region 22 has a radial depth 44. That is to say that the cut-out region 22 extends radially inwards from an outer edge 46 of the turbine wheel 10. Consequently, the shoulder 40, which separates the cut-out region 22 from the rest of the turbine wheel 10, has to run in an arc; by way of example, the shoulder 40 runs in the form of a circular segment. The profile of the shoulder 40 and therefore the shape of the cut-out region 22 are, however, not limited to a profile in the form of a circular segment. Tongue-shaped profiles are similarly conceivable, such that a larger region can be formed between the blades 20 of the turbine wheel 10 as the cut-out region 22. It is thereby possible for yet more material and therefore weight to be saved.

For the component stresses in the wheel back 18, it is advantageous if the axial thickness 26 of the wheel back 18 is greater than 1.5 times the axial thickness 24 of the at least one cut-out region 22.

In the case of the turbine wheel 10 according to the second embodiment, the balancing region 36 runs between the first diameter 30 and the third diameter 38.

For the rest, in terms of structure and function, the second embodiment of the exhaust-gas turbocharger, shown in FIGS. 3 and 4, corresponds to the first embodiment of the exhaust-gas turbocharger shown in FIGS. 1 and 2, reference being made in this respect to the above description of the first embodiment.

A third embodiment (not shown) of the exhaust-gas turbocharger differs from the first embodiment of the exhaust-gas turbocharger shown in FIGS. 1 and 2 in that the turbine wheel 10 has, in addition to the cut-out region 22 arranged on the rear side 23, at least one further cut-out region 22 on the flow side 41, in a manner corresponding to the second embodiment of the exhaust-gas turbocharger shown in FIGS. 3 and 4, reference being made in this respect to the above description of the second embodiment.

The third embodiment is thus a combination of the first and of the second embodiment, in which at least one cut-out region 22 is arranged in each case both on the flow side 41 and on the rear side 23 of the turbine wheel 10.

For the rest, in terms of structure and function, the third embodiment of the exhaust-gas turbocharger corresponds to the first embodiment of the exhaust-gas turbocharger shown in FIGS. 1 and 2, reference being made in this respect to the above description of the first embodiment.

1. An exhaust-gas turbocharger having comprising:
a compressor wheel;
a turbine wheel connected fixedly in terms of rotation to the compressor wheel via a shaft, the turbine wheel having a hub, a disc-like wheel back, and a plurality of blades extending radially from the hub and axially from the wheel back;
wherein the wheel back of the turbine wheel has at least one cut-out region of reduced axial thickness.

2. An exhaust-gas turbocharger according to claim 1, wherein the at least one cut-out region is delimited by a shoulder on the wheel back, said shoulder separating the at least one cut-out region of reduced axial thickness from the rest of the wheel back of non-reduced axial thickness.

3. An exhaust-gas turbocharger according to claim, wherein, in a radially outer region of the at least one cut-out region, the wheel back has an axial thickness which is smaller than one thirtieth of a diameter of the turbine wheel.

4. An exhaust-gas turbocharger according to claim 1, wherein the at least one cut-out region is formed on a rear side of the wheel back which is remote from the flow.

5. An exhaust-gas turbocharger according to claim 4, wherein the at least one cut-out region runs in an annular manner between a first diameter and a second diameter, the first diameter corresponding to a diameter of the wheel back.

6. An exhaust-gas turbocharger according to claim 5, wherein the turbine wheel has a balancing region, the balancing region having a substantially planar annular surface on the rear side of the turbine wheel from which material can be removed in order to balance out the turbine wheel.

7. An exhaust-gas turbocharger according to claim 6, the balancing region is located between the second diameter and a third diameter, the first diameter being greater than the second diameter and the second diameter being greater than the third diameter.

8. An exhaust-gas turbocharger according to claim 1, wherein the at least one cut-out region is formed on a flow side of the wheel back.

9. An exhaust-gas turbocharger according to claim 8, wherein the cut-out region is located between the blades.

10. An exhaust-gas turbocharger according to claim 2, 9, wherein the shoulder runs in an arc between the cut-out region and the rest of the wheel back, the shoulder being at a smaller distance from an axis of rotation centrally between two blades than in regions closer to the blades.

11. An exhaust-gas turbocharger according to claim 10, wherein the shoulder has a profile in the form of an arc of a circle.

12. An exhaust-gas turbocharger according to claim 1, wherein the turbine wheel comprises titanium aluminide.

13. An exhaust-gas turbocharger according to claim 12, wherein the turbine wheel comprises gamma TiAl.

14. An exhaust-gas turbocharger according to claim 2, wherein, in a radially outer region of the at least one cut-out region, the wheel back has an axial thickness which is smaller than one thirtieth of a diameter of the turbine wheel.

15. An exhaust-gas turbocharger according to claim 2, wherein the at least one cut-out region is formed on a rear side of the wheel back which is remote from the flow.

16. An exhaust-gas turbocharger according to claim 2, wherein the at least one cut-out region is formed on a flow side of the wheel back.

17. An exhaust-gas turbocharger according to claim 17, wherein the cut-out region is located between the blades.

18. An exhaust-gas turbocharger according to claim 18, wherein the shoulder runs in an arc between the cut-out region and the rest of the wheel back, the shoulder being at a smaller distance from an axis of rotation centrally between two blades than in regions closer to the blades.

19. An exhaust-gas turbocharger according to claim 1, wherein an axial thickness of the wheel back is greater than 1.5 times an axial thickness of the at least one cut-out region.

20. An exhaust-gas turbocharger comprising:
a compressor wheel;
a turbine wheel connected fixedly in terms of rotation to the compressor wheel via a shaft, the turbine wheel having a hub, a disc-like wheel back, and a plurality of blades extending radially from the hub and axially from the wheel back;
wherein the wheel back of the turbine wheel has at least one cut-out region of reduced axial thickness, the at least one cut-out region running in an annular manner between a first diameter and a second diameter, the first diameter corresponding to a diameter of the wheel back; and
wherein the turbine wheel has a balancing region, the balancing region having a substantially planar annular surface on the rear side of the turbine wheel from which material can be removed in order to balance out the turbine wheel, the balancing region being located between the second diameter and a third diameter, the first diameter being greater than the second diameter and the second diameter being greater than the third diameter.
